(19) United States
(12) Patent Application Publication
(10) Pub. No.: US 2017/0054210 A1
(43) Pub. Date: Feb. 23, 2017

(54) INTERFERENCE SUPPRESSION FOR ARRAY-BASED COMMUNICATIONS

(71) Applicant: Maxlinear, Inc., Carlsbad, CA (US)

(72) Inventors: Timothy Gallagher, Carlsbad, CA (US); Curtis Ling, Carlsbad, CA (US)

(21) Appl. No.: 15/238,808

(22) Filed: Aug. 17, 2016

Related U.S. Application Data
(60) Provisional application No. 62/206,355, filed on Aug. 18, 2015.
(60) Provisional application No. 62/258,660, filed on Nov. 23, 2015.

(51) Int. Cl. H01Q 3/26; H01Q 1/38; H01Q 5/55

(52) U.S. Cl. CPC H01Q 3/2611; H01Q 5/55; H01Q 1/38

(57) ABSTRACT

An array based communications system may comprise a plurality of element processors. Each element processor may comprise a desired beam generation circuit and a suppression beam generation circuit. The desired beam generation circuit may generate a first plurality of complex coefficients. A desired beam may be generated according to a first weighted sum comprising a plurality of digital datastreams weighted by a corresponding complex coefficient of the first plurality of complex coefficients. The suppression beam generation circuit may generate a second plurality of complex coefficients. A suppression beam may be generated according to a second weighted sum comprising the plurality of digital datastreams weighted by a corresponding complex coefficient of the second plurality of complex coefficients.

### CROSS-REFERENCE TO RELATED APPLICATIONS/INCORPORATION BY REFERENCE

This patent application makes reference to, claims priority to, and claims the benefit from U.S. Provisional Application Ser. No. 62/206,355, which was filed on Aug. 18, 2015 and U.S. Provisional Application Ser. No. 62/258,660, which was filed on Nov. 23, 2015. Each of the above applications is hereby incorporated herein by reference in its entirety.

### BACKGROUND

Limitations and disadvantages of conventional methods and systems for communication systems will become apparent to one of skill in the art, through comparison of such systems with some aspects of the present invention as set forth in the remainder of the present application with reference to the drawings.

### BRIEF SUMMARY OF THE INVENTION

Systems and methods are provided for per-element power control for array based communications, substantially as shown in and/or described in connection with at least one of the figures, as set forth more completely in the claims.

Advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1A shows a single-unit-cell transceiver array communicating with a plurality of satellites.

FIG. 1B shows details of an example implementation of the single-unit-cell transceiver array of FIG. 1A.

FIG. 2A shows a transceiver which comprises a plurality of the unit cells of FIG. 1B and is communicating with a plurality of satellites.

FIG. 2B shows details of an example implementation of the transceiver of FIG. 1A.

FIG. 3 shows a hypothetical ground track of a satellite system in accordance with aspects of this disclosure.

FIG. 4A depicts transmit circuitry of an example implementation of the unit cell of FIG. 1B.

FIG. 4B depicts an example implementation of the per-element digital signal processing circuit of FIG. 4A.

FIG. 4C depicts an example nine-element antenna array.

FIG. 4D illustrates use of an antenna weighting window and single clipping threshold for driving the example array of FIG. 4C.

FIG. 4D illustrates use of an antenna weighting window and window-weighted clipping thresholds for driving the example array of FIG. 4C.

FIG. 4E illustrates use of an antenna weighting window and tapered clipping thresholds for driving the example array of FIG. 4C.

FIG. 4F illustrates use of an antenna weighting window and tapered clipping thresholds for driving the example array of FIG. 4C.

FIG. 4G illustrates an example implementation of the coefficient generation circuitry of FIG. 4B.

FIG. 5 is a flowchart illustrating an example process for crest factor reduction in accordance with an example implementation of this disclosure.

FIG. 6 illustrates an example weighting window applied to an array of antenna elements.

FIG. 7A illustrates an example of per-antenna-element PAPR using a single clipping threshold across all elements of an antenna array.

FIG. 7B illustrates an example antenna pattern achieved using the single clipping threshold technique of FIG. 7A.

FIG. 8A illustrates an example of per-antenna-element PAPR when each antenna element's clipping threshold is scaled in proportion to the weighting window applied across the antenna array.

FIG. 8B illustrates an example of per-antenna-element PAPR using the window-weighted clipping technique of FIG. 8A.

FIG. 8C illustrates an example antenna pattern achieved using the window-weighted clipping technique of FIG. 8A.

FIG. 9A illustrates an example of per-antenna-element PAPR when using clipping thresholds whose absolute values decrease relative to the weighting window as the distance of the element from the center of the array increases.

FIG. 9B illustrates an example of per-antenna-element PAPR using the tapered clipping technique of FIG. 9A.

FIG. 9C illustrates an example antenna pattern achieved using the tapered clipping technique of FIG. 9A.

FIG. 10 is a flowchart illustrating an example process for generating a suppression/cancellation beam at a selected angle.

FIG. 11 illustrates suppression of interference among multiple beams transmitted by an antenna array.

FIG. 12 is a flowchart illustrating an example processes for suppressing interference among multiple beams transmitted by an antenna array.

### DETAILED DESCRIPTION OF THE INVENTION

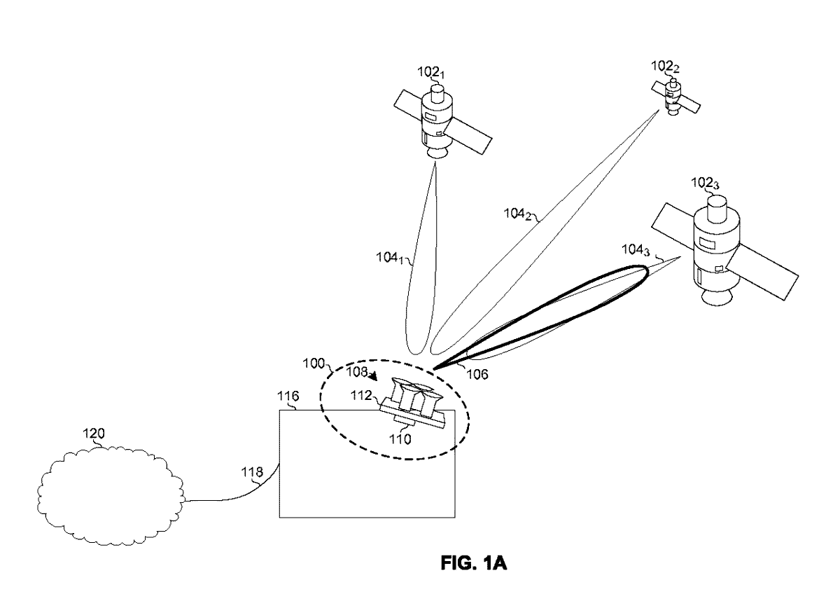

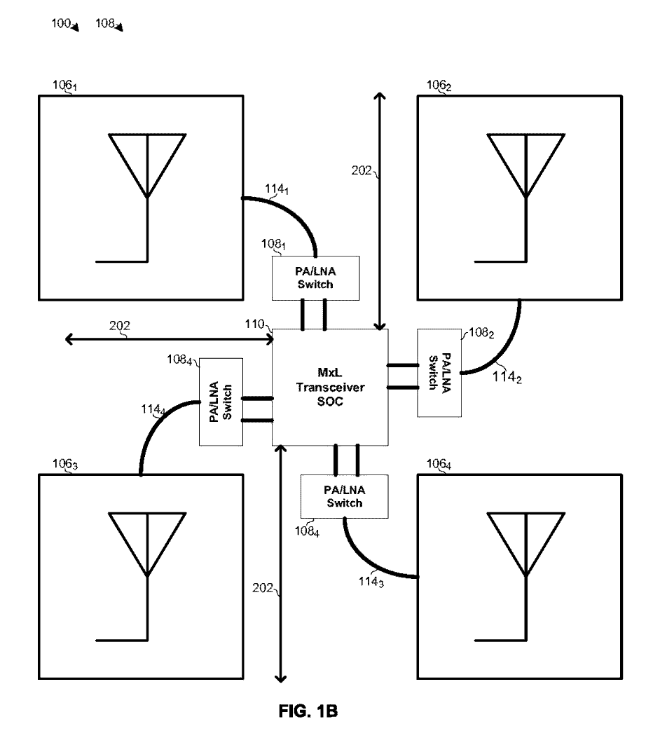

FIG. 1A shows a single-unit-cell transceiver array communicating with a plurality of satellites. Shown in FIG. 1A is a device 116 comprising a transceiver array 100 operable to communicate with a plurality of satellites 102. The device 116 may, for example, be a phone, laptop computer, or other mobile device. The device 116 may, for example, be a desktop computer, server, or other stationary device. In the latter case, the transceiver array 100 may be mounted remotely from the housing of the device 116 (e.g., via fiber optic cables). Device 116 is also connected to a network (e.g., LAN and/or WAN) via a link 118.

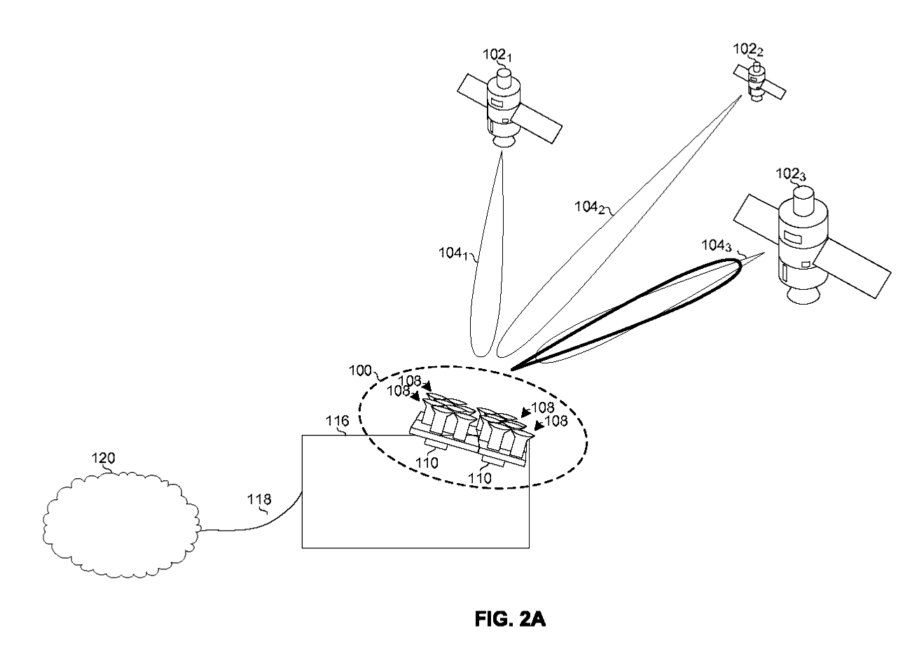

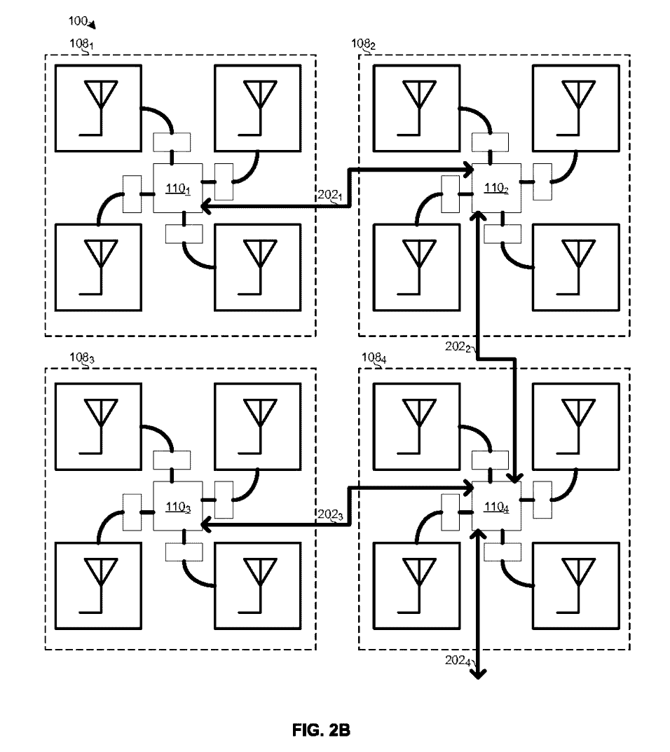

In an example implementation, the satellites 102 shown in FIGS. 1A and 2A are just a few of hundreds, or even thousands, of satellites having a faster-than-geosynchronous orbit. For example, the satellites may be at an altitude of approximately 1100 km and have an orbit periodicity of around 100 minutes.

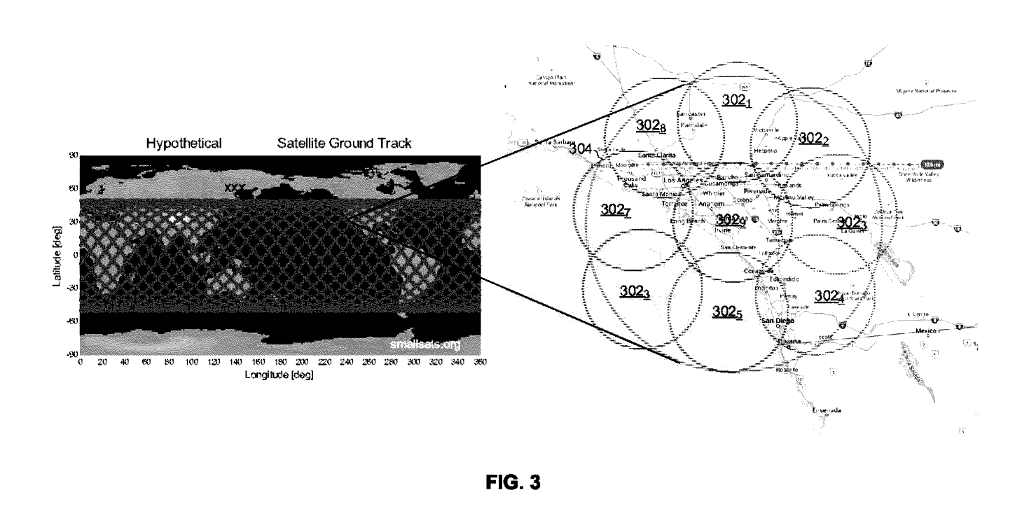

Each of the satellites 102 may, for example, be required to cover 18 degrees viewed from the Earth's surface, which may correspond to a ground spot size per satellite of ˜150 km radius. To cover this area (e.g., area 304 of FIG. 3), each satellite 102 may comprise a plurality of antenna elements generating multiple spot beams (e.g., the nine spot beams 302 of FIG. 3). In an example implementation, each of the satellites 102 may comprise one or more transceiver array, such as the transceiver array 100 described herein, operable to implement aspects of this disclosure. This may enable steering the coverage area of the spot beams without having to mechanically steer anything on the satellite 102. For example, when a satellite 102 is over a sparsely populated area (e.g., the ocean) but approaching a densely populated area (e.g., Los Angeles), the beams of the satellite 102 may be steered ahead such that they linger on the sparsely populated area for less time and on the densely populated area for more time, thus providing more throughput where it is needed.

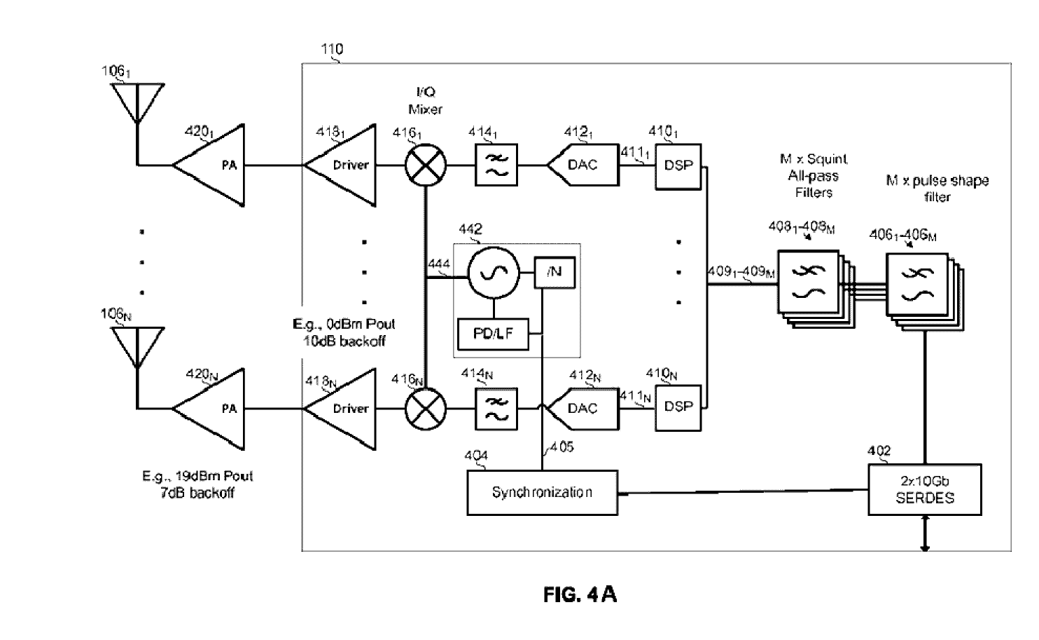

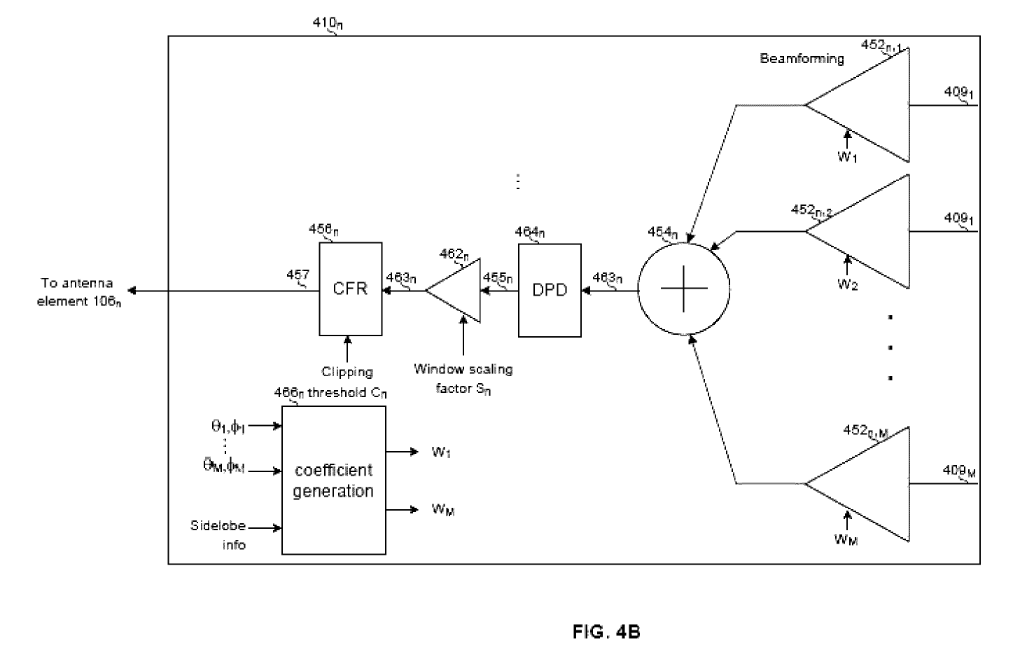

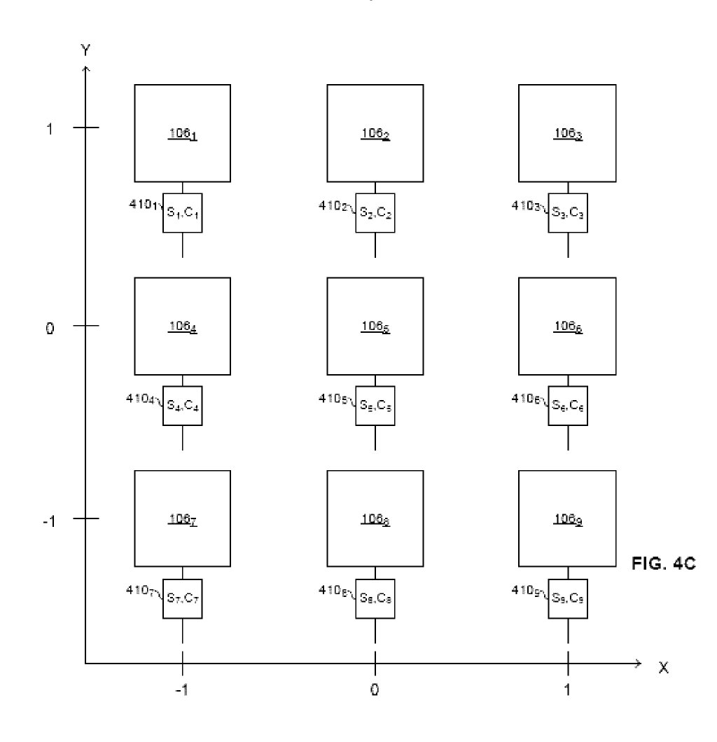

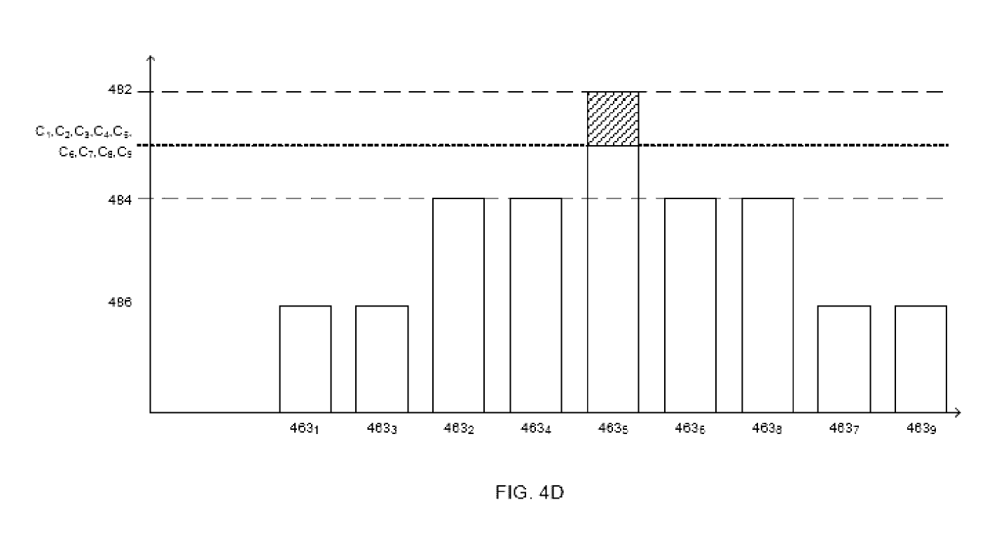

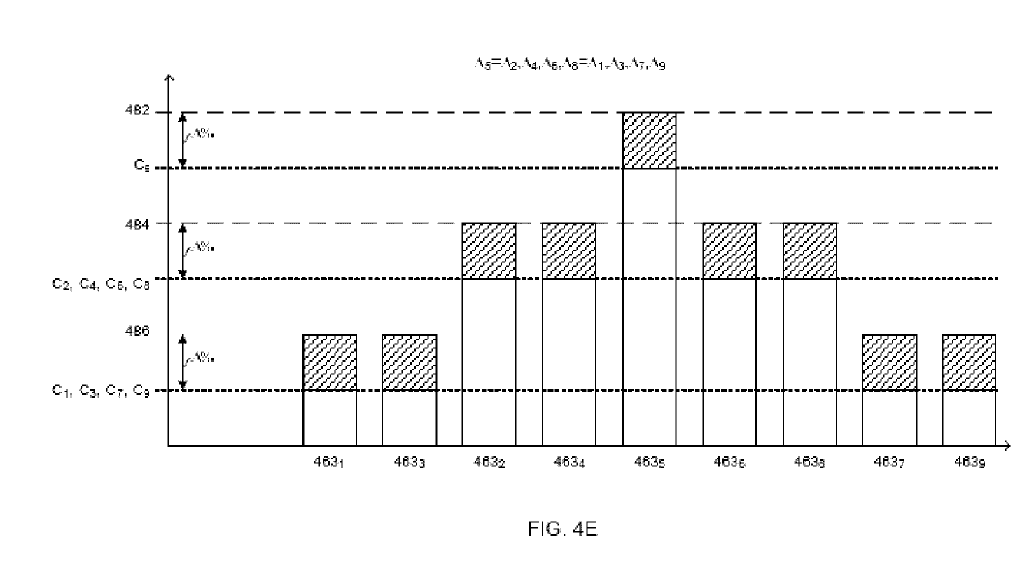

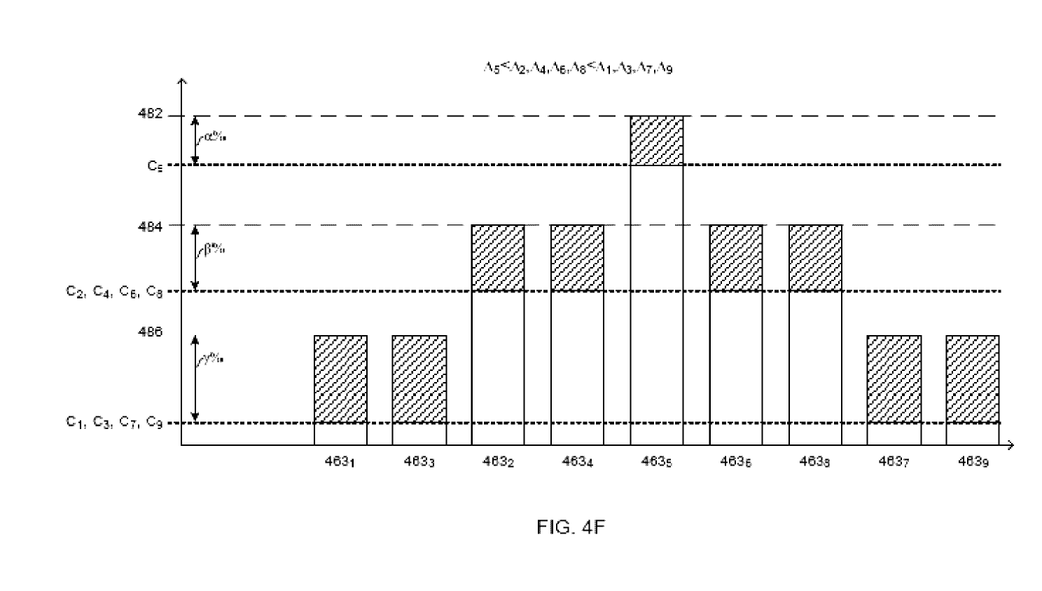

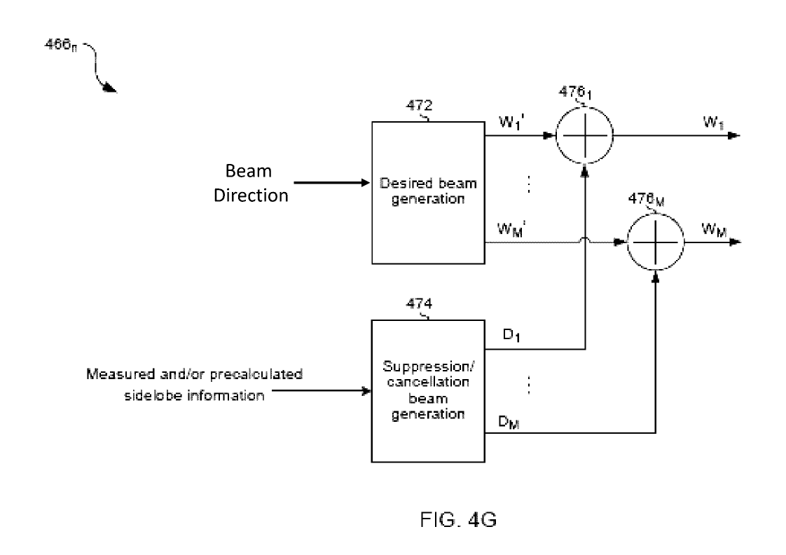

As shown in FIG. 1B, an example unit cell 108 of a transceiver array 100 comprises a plurality of antenna elements 106 (e.g., four antenna elements per unit cell 108 in the examples of FIGS. 1B and 2B; and ‘N’ per unit cell in the example of FIG. 4A), a transceiver circuit 110, and, for a time-division-duplexing (TDD) implementation, a plurality of transmit/receive switches 108. The respective power amplifiers (PAs) for each of the four antenna elements 106₁-106₄ are not shown explicitly in FIG. 1B but may, for example, be integrated on the circuit 110 or may reside on a dedicated chip or subassembly (as shown, for example, in FIG. 4A, below). The antenna elements 106, circuit 110, and circuit 108 may be mounted to a printed circuit board (PCB) 112 (or other substrate). The components shown in FIG. 1B are referred to herein as a “unit cell” because multiple instances of this unit cell 108 may be ganged together to form a larger transceiver array 100. In this manner, the architecture of a transceiver array 100 in accordance with various implementations of this disclosure may be modular and scalable. FIGS. 2A and 2B, for example, illustrate an implementation in which four unit cells 108, each having four antenna elements 106 and a transceiver circuit 110, have been ganged together to form a transceiver array 100 comprising sixteen antenna elements 106 and four transceiver circuits 110. The various unit cells 108 are coupled via lines 202 which, in an example implementation represent one or more data busses (e.g., high-speed serial busses similar to what is used in backplane applications) and/or one or more clock distribution traces (which may be referred to as a “clock tree”).

Use of an array of antenna elements 106 enables beamforming for generating a radiation pattern having one or more high-gain beams. In general, any number of transmit and/or receive beams are supported.

In an example implementation, each of the antenna elements 106 of a unit cell 108 is a horn mounted to a printed circuit board (PCB) 112 with waveguide feed lines 114. The circuit 110 may be mounted to the same PCB 112. In this manner, the feed lines 114 to the antenna elements may be kept extremely short. For example, the entire unit cell 108 may be, for example, 6 cm by 6 cm such that length of the feed lines 114 may be on the order of centimeters. The horns may, for example, be made of molded plastic with a metallic coating such that they are very inexpensive. In another example implementation, the antenna elements 106 may be, for example, stripline or microstrip patch antennas.

The ability of the transceiver array 100 to use beamforming to simultaneously receive from multiple of the satellites 102 may enable soft handoffs of the transceiver array 110 between satellites 102. Soft handoff may reduce downtime as the transceiver array 100 switches from one satellite 102 to the next. This may be important because the satellites 102 may be orbiting at speeds such that any particular satellite 102 only covers the transceiver array 100 for on the order of 1 minute, thus resulting in very frequent handoffs. For example, satellite 102₃ may be currently providing primary coverage to the transceiver array 100 and satellite 102₁ may be the next satellite to come into view after satellite 102₃. The transceiver array 100 may be receiving data via beam 104₃ and transmitting data via beam 106 while, at the same time, receiving control information (e.g., a low data rate beacon comprising a satellite identifier) from satellite 102₁ via beam 104₁. The transceiver array 100 may use this control information for synchronizing circuitry, adjusting beamforming coefficients, etc., in preparation for being handed-off to satellite 102₁. The satellite to which the transceiver array 100 is transmitting may relay messages (e.g., ACKs or retransmit requests) to the other satellites from which transceiver array 100 is receiving.

FIG. 4A depicts transmit circuitry of an example implementation of the unit cell of FIG. 1B. In the example implementation shown, circuit 110 comprises a SERDES interface circuit 402, synchronization circuit 404, local oscillator generator 442, pulse shaping filters 406₁-406_{M} (M being an integer greater than or equal to 1), squint filters 408₁-408_{M}, per-element digital signal processing circuits 410₁-410_{N}, DACs 412₁-412_{N}, filters 414₁-414_{N}, mixers 416₁-416_{N}, and drivers 418₁-418_{N}. The outputs of the PA drivers 418₁-418_{N} are amplified by PAs 420₁-420_{N} before being transmitted via antenna elements 106₁-106_{N}.

The SERDES interface circuit 402 is operable to exchange data with other instance(s) of the circuit 110 and other circuitry (e.g., a CPU) of the device 116.

The synchronization circuit 404 is operable to aid synchronization of a reference clock of the circuit 110 with the reference clocks of other instance(s) of the circuit 110 of the transceiver array 100.

The local oscillator generator 442 generates one or more local oscillator signals 444 based on the reference signal 405.

The pulse shaping filters 406₁-406_{M} (M being an integer greater than or equal to 1) are operable to receive bits to be transmitted from the SERDES interface circuit 402 and shape the bits before conveying them to the M squint processing filters 408₁-408_{M}. In an example implementation, each pulse shaping filter 406ₘ processes a respective one of M datastreams from the SERDES interface circuit 402.

Each of the per-element digital signal processing circuits 410₁-410_{N} is operable to perform processing on the signals 409₁-409_{M}. Each one of the circuits 410₁-410_{N} may be configured independently of each of the other ones of the circuits 410₁-410_{N} such that each one of the signals 411₁-411_{N} may be processed as necessary/desired without impacting the other ones of the signals 411₁-411_{N}. An example implementation of the per-element signal processing circuit 410 is described below with reference to FIG. 4B.

Each of the DACs 412₁-412_{N} is operable to convert a respective one of the digital signals 411₁-411_{N} to an analog signal. Each of the filters 414₁-414_{N} is operable to filter (e.g., anti-alias filtering) the output of a respective one of the DACs 412₁-412_{N}. Each of the mixers 416₁-416_{N} is operable to mix an output of a respective one of the filters 414₁-414_{N} with the local oscillator signal 444. Each of the PA drivers 418₁-418_{N} conditions an output of a respective one of the mixers 416₁-416_{N} for output to a respective one of PAs 420₁-420_{N}. In a non-limiting example, each PA driver 418ₙ (n being an integer between 1 and N) is operated at 10 dB from its saturation point and outputs a 0 dBm signal. In a non-limiting example, each PA 420ₙ is operated at 7 dB from its saturation point and outputs a 19 dBm signal.

FIG. 4B depicts an example implementation of the per-element digital signal processing circuit of FIG. 4A. The circuit 410ₙ comprises complex scaling circuits 452₁-452_{M}, a summer 454, a scaling circuit 462, a crest factor reduction circuit 456, a digital predistortion circuit 464, and coefficient generation circuit 466.

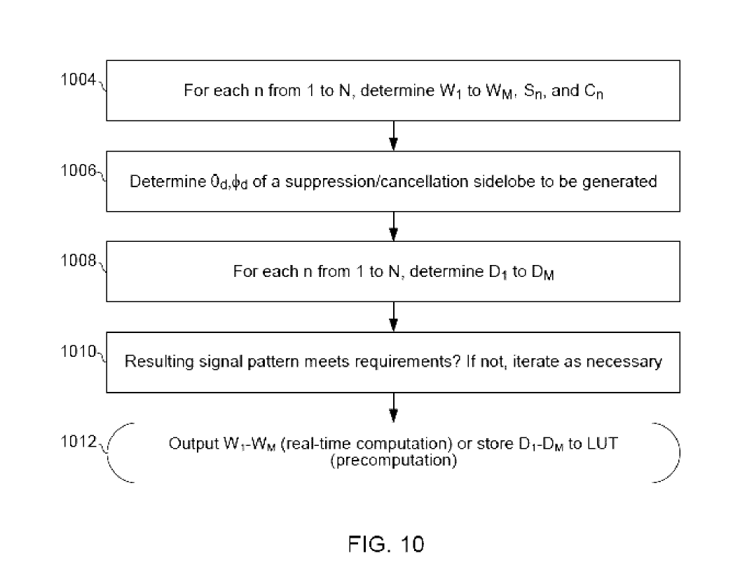

The weight generation circuit 466 receives the azimuthal angle θₘ and the elevation angle φₘ for each beam m of the M beams to be transmitted. The weight generation circuit 466 also receives information about one or more sidelobes that is desired to suppress/cancel. The sidelobes may be the result of the operations performed by the CFR circuit 456. Example details of selecting the sidelobes to be suppressed and calculating the coefficients L₁^{d} to L_{M}^{d} are described below with reference to FIG. 10. An example implementation of the weight generation circuitry 466 is described below with reference to FIG. 4G.

Each of the complex scaling circuits 452₁-452_{M} is operable to apply a complex beamforming coefficient generated by circuit 466 to (i.e., adjust the phase and amplitude of) a respective one of signals 409₁-409_{M}.

The summer 454 is operable to combine the M signals from the scaling circuits 452₁-452_{M} to generate signal 463.

The digital predistortion circuit 464 is operable to modify (“predistort”) the signal 463ₙ to generate signal 455ₙ the result of the predistortion being suppression/cancellation of out-of-band distortion which will subsequently be generated by crest factor reduction circuit 456.

The scaling circuit 462ₙ is operable to apply a gain Sₙ according to the array weighting window in use. Accordingly, the gain Sₙ used for any particular antenna element 106ₙ may depend on the position of the antenna 106ₙ within the array. For example, referring to the example nine-element array of FIG. 4C, the gain S₁ applied by scaling element 462₁ may be different than the gain S₂ and so on. In an example implementation, the gain Sₙ of any scaling element 462ₙ may be a function of the X and Y indexes of antenna element 106n. As just one example, for values of n from 1-9 in the example of FIG. 4C, Sₙ may depend on \sqrt{Xₙ²+Yₙ²} (i.e., depend on the distance from the center of the array), where Xₙ is the X index of antenna element 106ₙ (e.g., Xₙ=−1 for n=1, Xₙ=0 for n=2, Xₙ=1 for n=3, Xₙ=−1 for n=4, and so on), and Yₙ is the Y index of antenna element 106ₙ (e.g., Yₙ=1 for n=1, Yₙ=1 for n=2, Yₙ=1 for n=3, Yₙ=0 for n=4, and so on).

Returning to FIG. 4B, The crest factor reduction circuit 456 then operates on the signal 463 to determine if reduction of its peak-to-average power ratio (PAPR) is desired and, if so, to try and reduce the PAPR. In this manner, the PAPR may be managed separately for each transmit chain/antenna element.

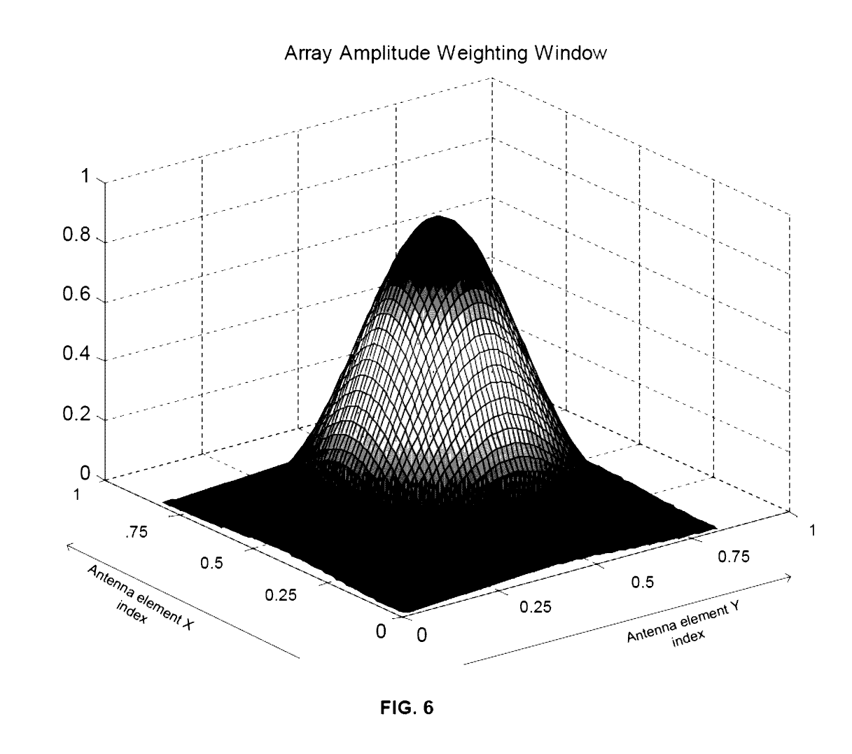

PAPR reduction performed by circuit 456ₙ comprises digitally clipping the signal 463 if it is above a determined clipping threshold Cₙ. 4D-4F illustrate three example clipping techniques for the example nine-antenna array of FIG. 4C. In each of FIGS. 4D-4F, S₅ is set such that the peak power of signal 463₅ is level 482; S₁, S₃, S₇, and S₉ are set such that the peak power of each of signals 463₁, 463₃, 463₇, and 463₉ is level 484; and S₂, S₄, S₆, and S₈ are set such that the peak power of each of signals 463₂, 463₄, 463₆, and 463₈ is level 486. This weighting window is just an example and is used in each of FIGS. 4D-4F for comparison of various clipping techniques. A 3-D plot of this type of weighting window is shown in FIG. 6. It is also noted that, for purposes of illustration, each signal 463₁-463₉ in FIGS. 4D-4F is shown swinging to the limit determined by the weighting window. In another example implementation, the CFR circuit 456 performs soft compression instead of, or in addition to, clipping. For example, it may perform soft compression above a first threshold and then clipping above a second threshold.

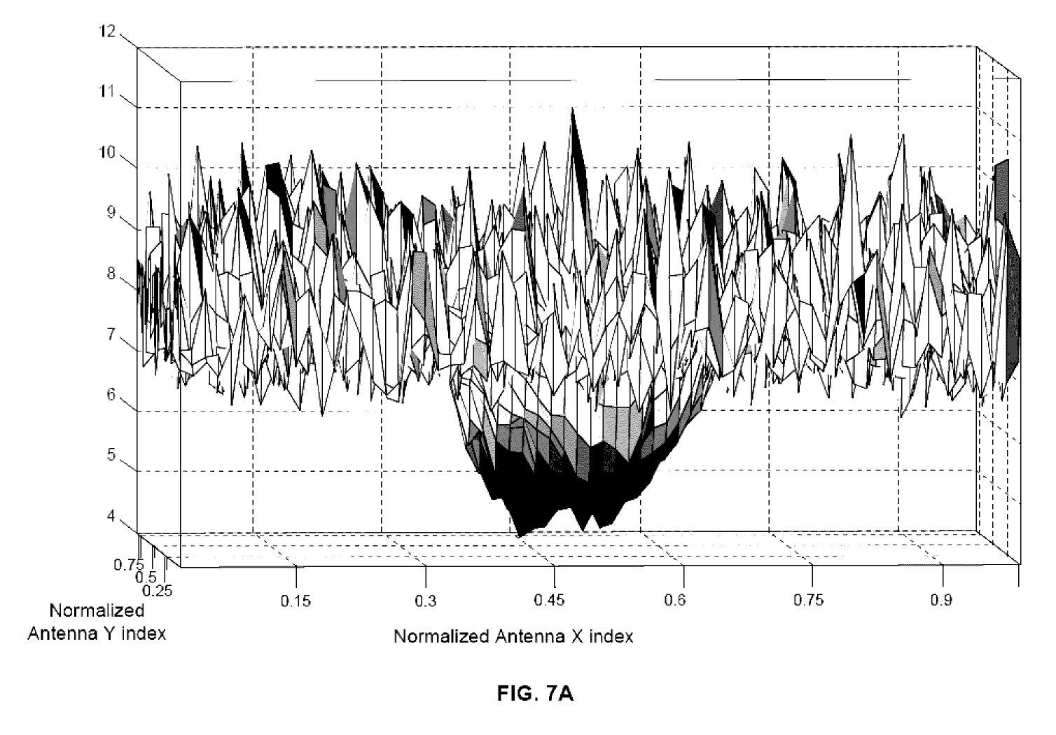

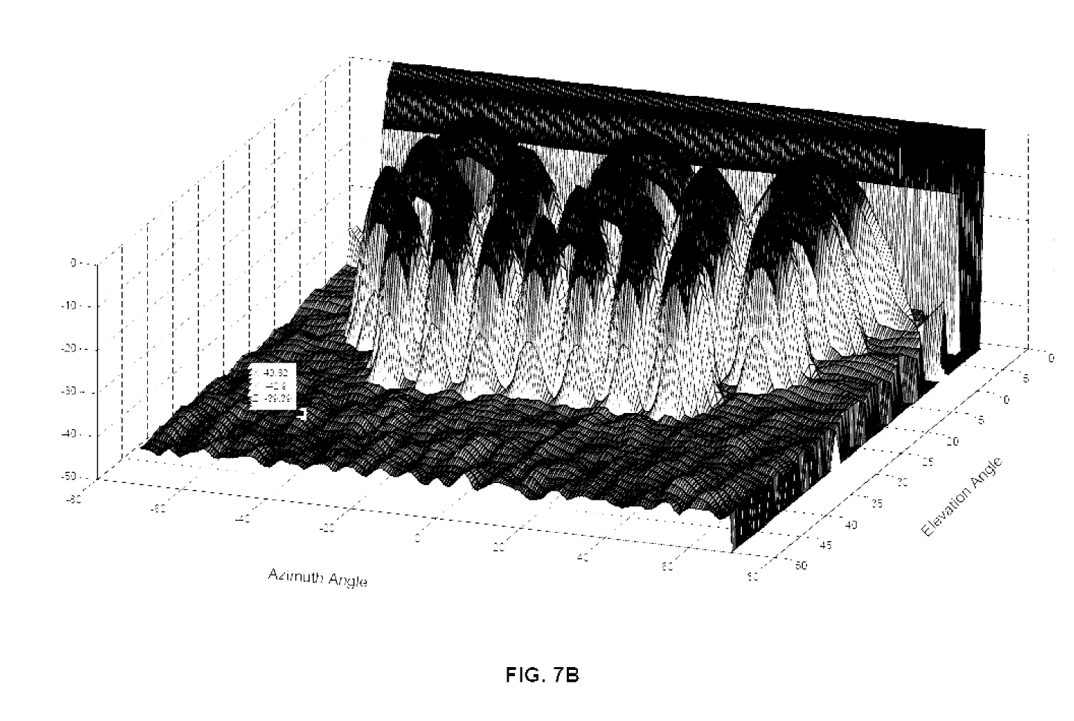

A first example clipping technique, shown in FIG. 4D, comprises using the same absolute clipping threshold for each of the scaling circuits 462ₙ. In the example shown, each of clipping thresholds C₁-C₉ is set to a level which is located between 482 and 484. In this example, only signal 463₅ may be clipped since the applied window prevents the other signals 463 from reaching the clipping threshold. The cross-hatched area indicates the clipped portion of the signal. Referring briefly to FIG. 7A, using this clipping technique may result in lower PAPR where clipping occurs (near the center element(s) in the example shown). Referring briefly to FIG. 7B, an example antenna pattern comprising 27 desired beams from an array using the clipping scheme of FIG. 4C is shown.

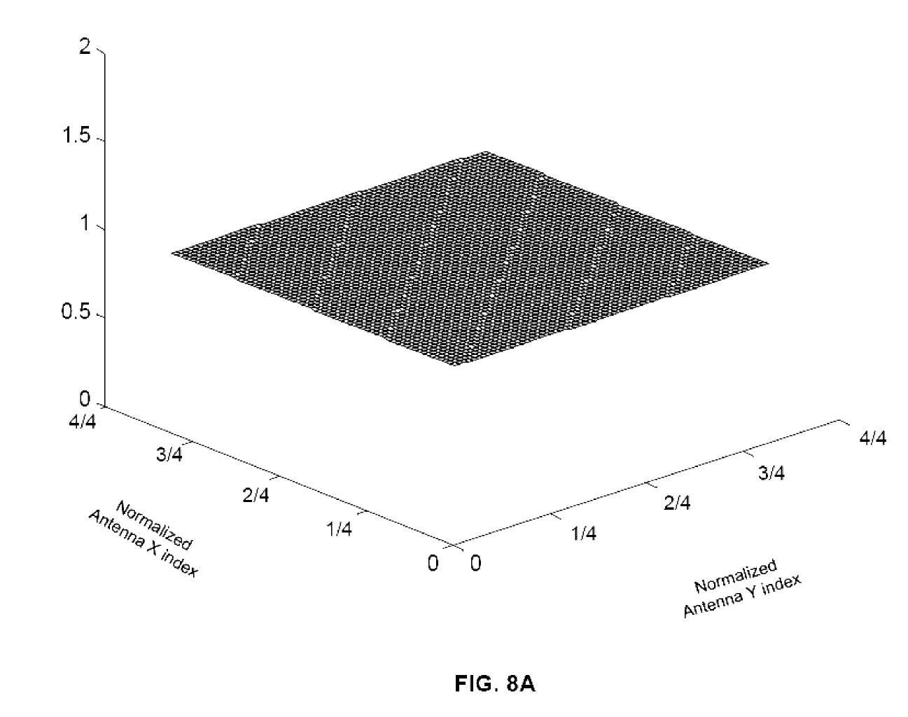

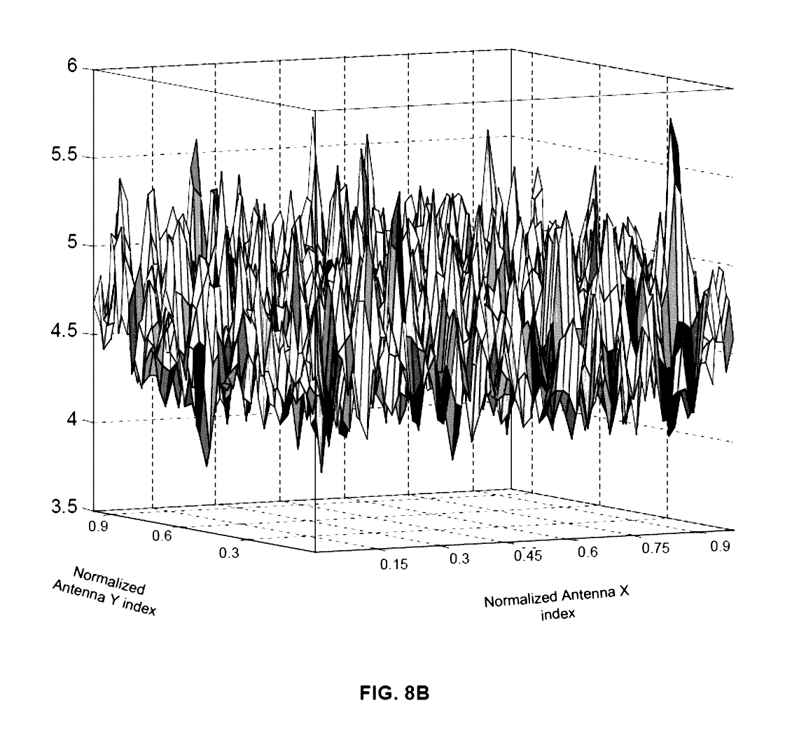

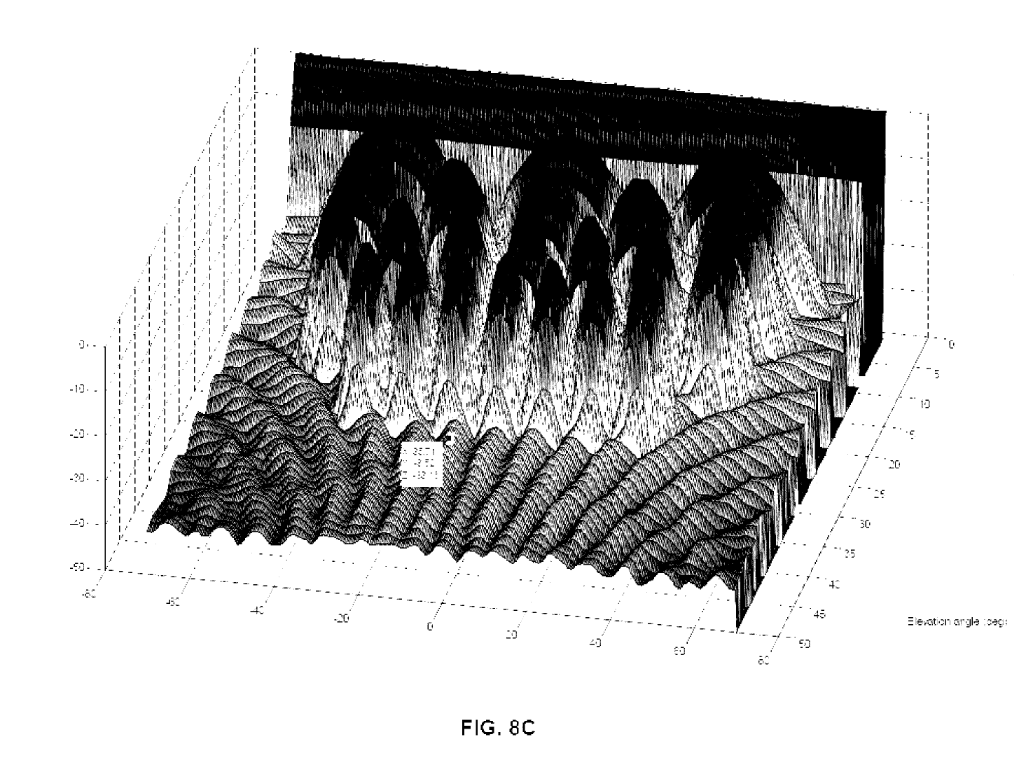

A second example clipping technique, shown in FIG. 4E, comprises using the same relative (relative to the weighting window) clipping threshold for each of the antenna elements in the array. In the example shown in FIG. 4E, each of clipping thresholds Cₙ is set to Δ% below the limit determined by the weighting window (and set by 462ₙ). In this example, up to Δ% of each signal 463 may be clipped. Referring briefly to FIG. 8A, the clipping technique of FIG. 4E is illustrated by a 3D plot showing clipping level relative to the window weighting. As shown in FIG. 8B, this clipping technique may result in relatively uniform PAPR across the array. This uniform PAPR may be desirable but, as shown in FIG. 8C, may come at the cost of increased undesired side lobe levels as compared to FIG. 7B.

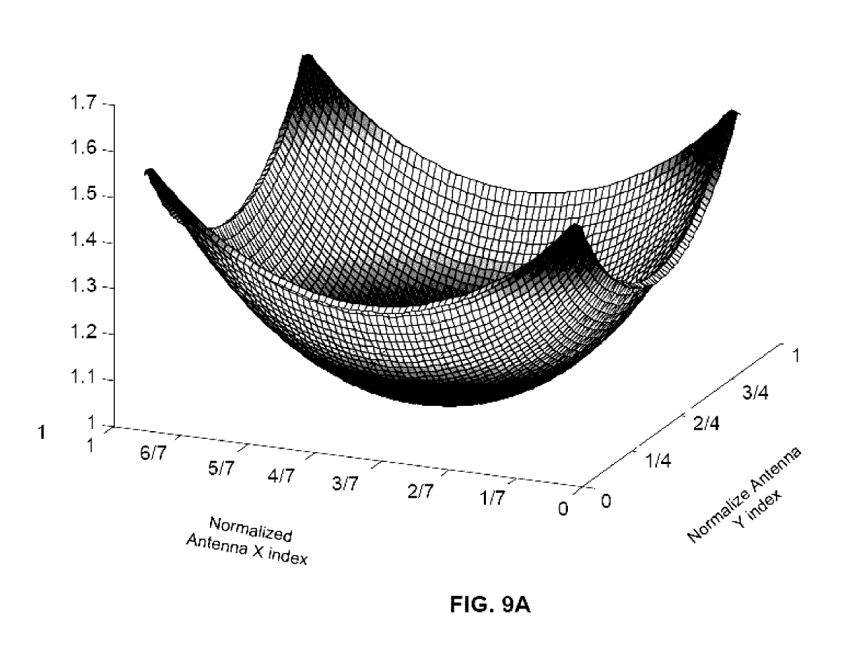

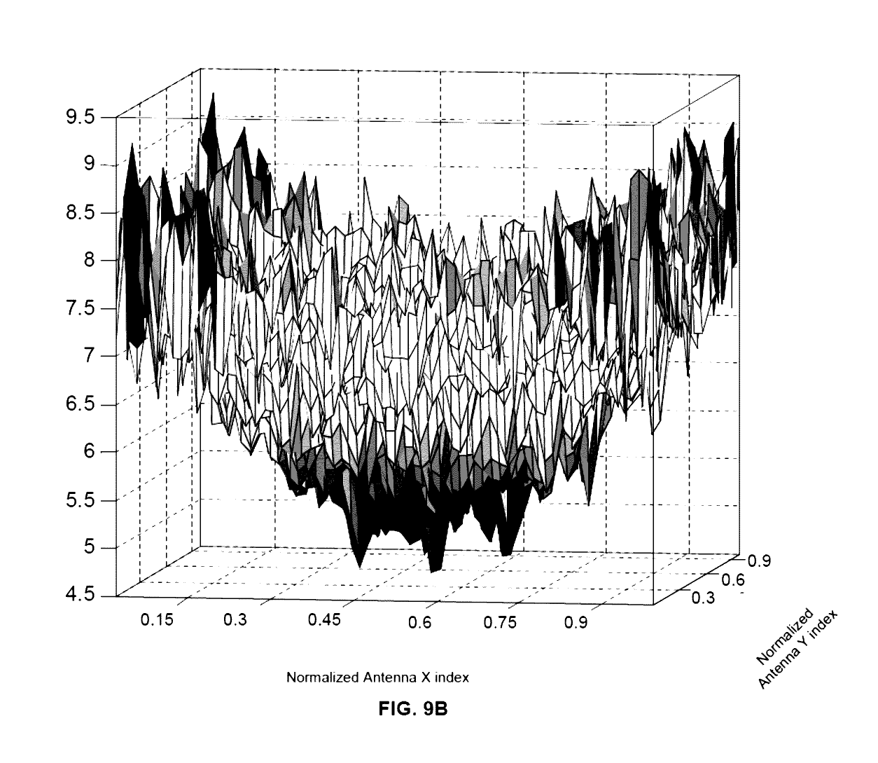

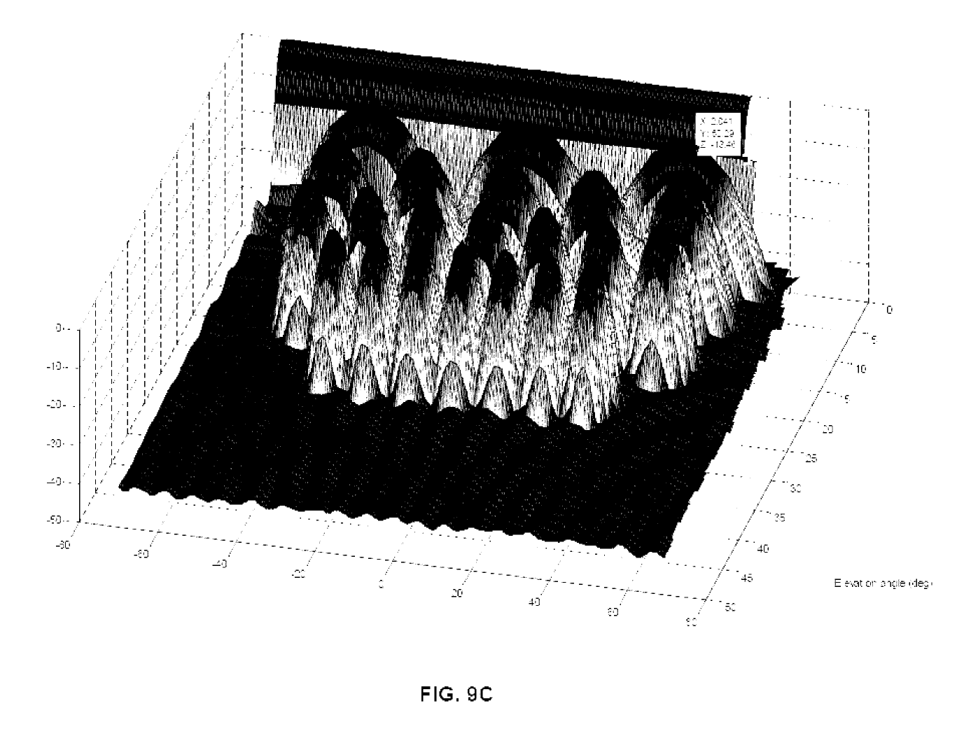

A third example clipping technique, shown in FIG. 4F, comprises using different relative (relative to the weighting window) clipping thresholds for scaling circuits 462. In the example shown in FIG. 4F, the relative threshold is tapered based on distance from the center of the array. That is, C₅ is set α% below level 482; C₂, C₄, C₆, and C₈ are set β% below 484, and C₁, C₃, C₅, and C₇ are set γ% below level 486, wherein α<β<γ. Referring briefly to FIG. 9A, the clipping technique of FIG. 4E is illustrated by a 3D plot showing a clipping level relative to the window weighting for an example implementation. As shown in FIG. 9B, this clipping technique may result in PAPR that tapers off toward the center of the array. As shown in FIG. 9C, this clipping technique may achieve side lobe levels that are between those of FIGS. 7B and 8C.

Now referring to FIG. 4G, the example coefficient generation circuit 466ₙ comprises desired beam generation circuit 472, suppression/cancellation beam generation circuit 474, and combiners 476₁-476_{M}. The desired beam generation circuit 472 generates the coefficients W₁′-W_{M}′ for achieving a desired beam, each beam n having angles (θₙ, φₙ). The suppression/cancellation beam generation circuit 474 generates coefficients D₁-D_{M} that suppress/cancel an undesired beam at (θ_{d}, φ_{d}).

In an example implementation, the information received by circuit 474 comprises the angle pair (θ_{d}, φ_{d}) at which it is desired to generate a cancellation/suppression beam. This angle pair may, for example, correspond to the location of a known receiver which utilizes the same frequency band(s) as the array 100, and which it is desired/necessary to protect from interference. The angle pair may evolve along with on the current position of the array 100. For example, when the array 100 is part of a satellite, the angle pair may change as the satellite travels along its orbit such that it tracks the location of the known receiver. Although a single cancellation/suppression beam is generated in the example, the number generated may be limited only by desired computational complexity. It is noted, however, that often there are only a few angle pairs that are of interest at any given time (e.g., only a few receivers or other devices which may be sensitive to the sidelobes which, even without the additional suppression/cancellation beam, are very weak).

Given the angle pair at which it is desired to generate the cancellation/suppression beam, the circuitry 474 may determine the coefficients D₁-D_{M} which result in the suppression/cancellation beam. In an example implementation, the coefficients D₁-D_{M} may be predetermined based on measurement and and/or numerical analysis and stored in a look-up table indexed by the angle pair. In another example implementation, the coefficients D₁-D_{M} may be computed on the fly. Such computation may use an iterative, numerical optimization technique.

The coefficients D₁-D_{M} may depend on the scaling factor Sₙ. Accordingly, where the scaling factor Sₙ is dynamic, Sₙ may also be used for indexing the lookup table and/or be an input to the computation engine that calculates D₁-D_{M}.

The coefficients D₁-D_{M} may depend on the clipping threshold Cₙ being applied and thus, where the clipping threshold Cₙ is dynamic, it may also be used for indexing the lookup table and/or be an input to the computation engine that calculates D₁-D_{M}.

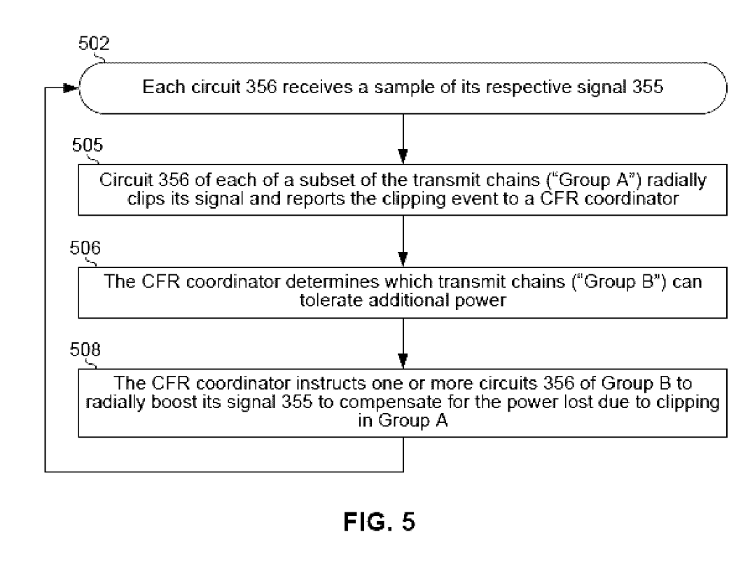

Now referring to FIG. 5, in block 502, circuit 456 of each transmit chain receives a sample of its respective signal 455. In block 505, circuit 456 of each of a subset of the transmit chains (“Group A”) determines that the power of its sample is above a threshold and radially clips (i.e., clips the amplitude without affecting the phase) the sample to a level equal to or below the threshold. In an example implementation, the clipping may comprise a series of clips with filtering in between, with the series of clips and filters configured to optimize out-of-band power and/or in-band EVM.

Each circuit 456 of Group A then reports the clipping event to a CFR coordinator (e.g., one of the circuits 456 of one of the circuits 110 or array 100 may be selected as CFR coordinator based on some selection criteria, a CPU of the device 116 may operate as CFR coordinator, or some other circuitry of the transceiver array 100). In block 506, the CFR coordinator determines which transmit chains (“Group B”) can tolerate additional power (e.g., because there is at least a determined amount of headroom between their respective sample powers and the clipping threshold). In block 508, the CFR coordinator computes compensating signals to be applied to one or more of the signal(s) 457 in Group B. The compensating signals may radially boost the power of such signals 457 in Group B a manner that compensates for the power “lost” in Group A due to the clipping. The compensating signal(s) may replace some or all of the power “lost” due to clipping. Due to the fact that the lost power radiates in a certain radiation pattern that can be precomputed (because the lost power only drives antennas elements of Group A), the amplitude and phase of the compensating signal(s) can be computed to restore the signal 457 in the desired directions of each beam. In an example implementation in which N beams are transmitted, each of compensating signals for each of the N beams may be computed individually, and then the N compensating signals may be superimposed. This may be applied in situations where the side lobes produced by the compensating signals are sufficiently low. In other situations, more complex methods for calculating the compensating signals may be used.

Given constant adjacent channel leakage ratio and sidelobe level, the adding back of clipped power may enable a clipping threshold that is 0.5 dB or more below the clipping threshold that would otherwise be required. This translates to significant improvement in PA efficiency.

FIG. 10 is a flowchart illustrating an example process for generating a suppression/cancellation beam at a selected angle. The process begins with block 1004 in which, for each transmit path/antenna elements n, W₁-W_{M}, Sₙ, and Cₙ are determined to achieve an initial desired antenna pattern. Next, in block 1006, the angle pair (θ_{d}, φ_{d}) at which is it desired to generate a cancellation/suppression beam is determined. This may be determined based on, for example, the current location of the array 100 and known locations which are sensitive to interference from the array 100 (e.g., retrieved from a database of such locations). For example, the database may be queried for any such locations which are within a certain range of the current position of the array 100. In block 1008, D₁-D_{M} are determined for each transmit path/antenna element n. The determined values of D₁-D_{M} may depend on, for example, Sₙ, Cₙ, (θ_{d}, φ_{d}), and configuration of the digital predistortion circuitry 464. In block 1010, the overall antenna pattern and/or frequency content of the transmitted signal resulting from W₁-W_{M}, Sₙ, Cₙ, D₁-D_{M}, and the DPD circuit 464 is measured or calculated and compared to requirements. If the antenna pattern does not meets requirements, then another iteration of steps 1004-1008 may be performed using the results from the previous iteration as an input. If the antenna pattern does meet requirements, then, in block 1012, D₁-D_{M} are selected for use and either stored to a lookup table or some other data structure for future use (in the case of precomputing D₁-D_{M}), or output for generation of W₁-W_{M} (in the case of real-time computation of D₁-D_{M} during operation of the array 100).

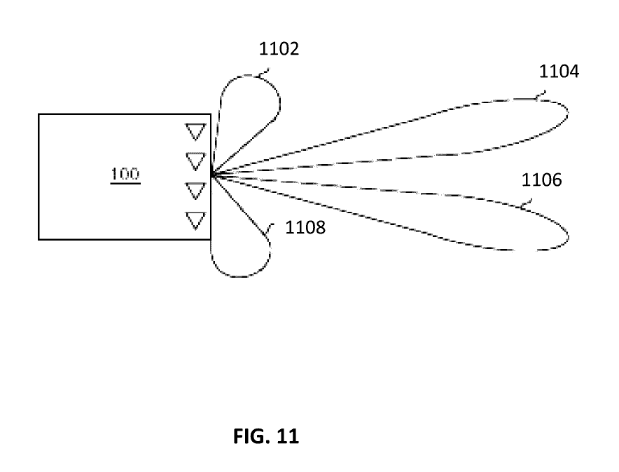

Referring to FIG. 11, shown are four beams 1102, 1104, 1106, and 1108 generated by a transceiver array 100. Each of the beams may be a desired beam or an undesired side lobe. Each of the beams may interfere with each other (i.e., 1102 leaks onto 1104, 1106, and 1108; 1104 leaks onto 1102, 1106, and 1108; 1106 leaks onto 1102, 1104, and 1108, and 1108 leaks onto 1102, 1104, and 1106). Although aspects of this disclosure can be used for cancelling all such interference, interference between adjacent beams may have the biggest impact and thus cancelling for only sets of adjacent beams may be sufficient (i.e., cancel the leakage between 1102 and 1104, between 1104 and 1106, and between 1106 and 1108).

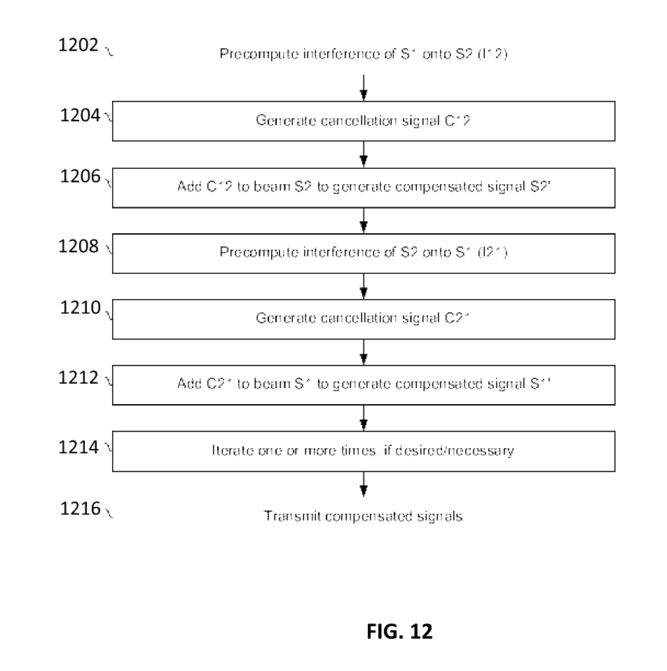

Now referring to FIG. 12, an example process for cancelling interference will be described with reference to two signals S1 and S2 which are to be transmitted on any two of the beams 1102, 1104, 1106, and 1108 (e.g., on beams 1104 and 1106).

In block 1202, the interference of S1 onto S2 (denoted 112) that would happen if the two signals were transmitted is computed based on characteristics of the transceiver array 100 (e.g., number of antenna elements, size of antenna elements, coupling between antenna elements, and/or the like) and of the beams on which the two signals are to be transmitted (e.g., direction at which the beams are to be transmitted, center frequency on which the beams are to be transmitted, and/or the like).

In block 1204, a cancellation signal C12, that is, a signal that when added to signal S2 it will cancel the interference from signal S1, is generated. In an example implementation, B12 may be compensated/shaped to account for the fact that I12 may be a function of angle. That is, I12 might vary across the range of angles covered by the beam, and B12 may be compensated to account for such variation such that the interference may be well suppressed at angles other than just the angle of peak beam power (so that when the intended receiver is located off-center from the beam peak, it still benefits from the interference suppression).

In block 1206, C12 is added to signal S2 to generate S2′.

In block 1208, the interference of S2 onto S1 (denoted I21) that would happen if the two signals were transmitted is computed based on characteristics of the transceiver array 100 (e.g., number of antenna elements, size of antenna elements, coupling between antenna elements, and/or the like) and of the beams on which the two signals are to be transmitted (e.g., direction at which the beams are to be transmitted, center frequency on which the beams are to be transmitted, and/or the like).

In block 1210, a cancellation signal C21, that is, a signal that when added to signal S1 it will cancel the interference from signal S2, is generated. In an example implementation, B21 may be compensated/shaped to account for the fact that I21 may be a function of angle. That is, I21 might vary across the range of angles covered by the beam, and B21 may be compensated to account for such variation such that the interference may be well suppressed at angles other than just the angle of peak beam power (so that when the intended receiver is located off-center from the beam peak, it still benefits from the interference suppression).

In block 1212, C21 is added to signal S1 to generate S1′.

In block 1214, the process of blocks 1202 through 1212 may be repeated one or more times, with each time taking into account the results from the previous iteration. For example, in a second iteration, interference of S1′ onto S2′ may be calculated and used to generate C12′ and S2″, interference of S2′ onto S1′ may be calculated and used to generate C21′ and S1″, and so on.

In block 1216, the compensated signals are transmitted.

In an example implementation, cross-polarization interference may be cancelled using a similar technique. For example, lobe 1104 of FIG. 11 may represent two beams of different polarizations and these beams may interfere with each other. A similar process of predicting the interference, adding a cancelling signal, and then iterating as desired/necessary may be used. In an example implementation, such cross-polarization interference suppression might be done at the receiver while the process of FIG.12 is done at the transmitter—thus distributing the computational load between the two devices. In another example implementation, both types of interference cancellation may be performed in the transmitter.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. An array based communications system comprising:
a plurality of element processors, each element processor of the plurality of element processors being operable to receive a plurality of digital datastreams, each element processor comprising:
a desired beam generation circuit operable to generate a first plurality of complex coefficients, a desired beam being generated according to a first weighted sum, the first weighted sum comprising each of the plurality of digital datastreams weighted by a corresponding complex coefficient of the first plurality of complex coefficients; and
a suppression beam generation circuit operable to generate a second plurality of complex coefficients, a suppression beam being generated according to a second weighted sum, the second weighted sum comprising each of the plurality of digital datastreams weighted by a corresponding complex coefficient of the second plurality of complex coefficients.

2. The array based communications system of claim 1, wherein the array based communications system comprises a plurality of wireless transmitters, each wireless transmitter of the plurality of wireless transmitters being operable to transmit a modulated analog signal corresponding to the first weighted sum and the second weighted sum from each of the plurality of element processors.

3. The array based communications system of claim 2, wherein each of the plurality of wireless transmitters is attached to a horn mounted to a printed circuit board with waveguide feed lines.

4. The array based communications system of claim 1, wherein the first plurality of complex coefficients and the second plurality of complex coefficients are combined before the plurality of digital datastreams are weighted.

5. The array based communications system of claim 1, wherein the suppression beam suppresses signals directed to a location that is sensitive to interference.

6. The array based communications system of claim 1, wherein the suppression beam generation circuit queries a database for a location in the vicinity of the array based communications system that is sensitive to interference.

7. The array based communications system of claim 1, wherein the suppression beam suppresses one or more sidelobes of the desired beam.

8. The array based communications system of claim 1, wherein the suppression beam from a first element processor of the plurality of element processors suppresses one or more sidelobes of the desired beam from a second element processor of the plurality of element processors.

9. A method for array based communications, the method comprising:
generating a first plurality of complex coefficients;
determining that the first plurality of complex coefficients correspond to a signal transmission in an undesired direction;
generating a second plurality of complex coefficients to suppress the signal transmission in the undesired direction;
generating one or more weighted sums of a plurality of digital datastreams using the second plurality of complex coefficients as weights.

10. The method of claim 9, wherein the method comprises wirelessly transmitting one or more modulated analog signals corresponding to the one or more weighted sums weighted sums.

11. The method of claim 9, wherein the method comprises combining the first plurality of complex coefficients and the second plurality of complex coefficients before weighting the plurality of digital datastreams.

12. The method of claim 9, wherein the undesired direction is toward a location that is sensitive to interference.

13. The method of claim 9, wherein the method comprises querying a database for a location in the vicinity of an array based communications system that is sensitive to interference.

14. The method of claim 9, wherein the undesired direction coincides with one or more sidelobes of a desired beam.

15. A machine-readable storage having stored thereon, a computer program having at least one code section for networking, the at least one code section being executable by a machine for causing the machine to perform steps comprising:
generating a first plurality of complex coefficients;
determining that the first plurality of complex coefficients correspond to a signal transmission in an undesired direction;
generating a second plurality of complex coefficients to suppress the signal transmission in the undesired direction;
generating one or more weighted sums of a plurality of digital datastreams using the second plurality of complex coefficients as weights.

16. The machine-readable storage of claim 15, wherein the at least one code section is executable by the machine for causing the machine to wirelessly transmit one or more modulated analog signals corresponding to the one or more weighted sums weighted sums.

17. The machine-readable storage of claim 15, wherein the at least one code section is executable by the machine for causing the machine to combine the first plurality of complex coefficients and the second plurality of complex coefficients before weighting the plurality of digital datastreams.

18. The machine-readable storage of claim 15, wherein the undesired direction is toward a location that is sensitive to interference.

19. The machine-readable storage of claim 15, wherein the at least one code section is executable by the machine for causing the machine to query a database for a location in the vicinity of an array based communications system that is sensitive to interference.

20. The machine-readable storage of claim 15, wherein the undesired direction coincides with one or more sidelobes of a desired beam.
